(19) United States
(12) Patent Application Publication
(10) Pub. No.: US 2006/0181885 A1
(43) Pub. Date: Aug. 17, 2006

(54) Light sources embedded in panels

(75) Inventor: Joel Djong Seng Tong, Singapore (SG)

Correspondence Address: MICHAEL MOLINS;MOLINS & CO., SUITE 5, LEVEL 6, 139 MACQUARIE ST, SYDNEY NSW, 2000, AU

(73) Assignee: Joel Djong Seng Tong

(21) Appl. No.: 11/056,112

(22) Filed: Feb. 14, 2005

(51) Int. Cl. F21V 19/00

(52) U.S. Cl. 362/382

(57) ABSTRACT

A shelf has at least a first panel with an upper surface and a lower surface. The upper surface has a recess formed in it. The recess has in it a module carrying one or more LED sources of illumination. In preferred embodiments an upper surface of the module is flush with the upper surface of the panel. The LEDs shine through the underside of the shelf to illuminate objects under the shelf.

### FIELD OF THE INVENTION

The invention relates to shelving and more particularly to shelving or other forms of panels in which light sources are embedded.

### BACKGROUND OF THE INVENTION

Multi-tier shelves made of wood, acrylic, glass or metal are widely used in a variety of domestic, commercial, industrial and retail situations. Objects placed on shelves are often illuminated by conventional lamps installed at the top of or near a particular display unit. Ceiling down-lights (with or without tracks) are also commonly used. In many instances, good illumination is limited to the top shelves where light is cast directly onto the objects supported by shelf surfaces. Some light will penetrate transparent glass shelves but losses occur because light is reflected of off the shelf-supported objects. These shelf-supported objects will prevent light from reaching lower shelves, casting shadows. Further, light distribution is often uneven. Prior art solutions include under-shelf lighting units that use convention fluorescent tubes or halogen lamps. However, to make a shelving system aesthetic, a ledge is usually applied along the front edge to hide these under-cabinet or under-shelf lamps and their components.

### OBJECTS AND SUMMARY OF THE INVENTION

It is an object of the invention to embed a small light source into a shelf without the requirement of a separate ledge, thus creating an aesthetically pleasing form of predictable and even illumination.

Accordingly, there is provided a shelf or other surface comprising an upper layer and a lower layer between which is embedded a source of illumination and its associated circuitry. At least one of the layers has openings through which the light sources cast their illumination.

In preferred embodiments of the invention, the lower layer is provided with openings and the light sources are LED light sources.

In particularly preferred embodiments, the associated circuitry runs along an edge of the panel and is concealed by a channel. Both layers of the panel fit within the channel.

### BRIEF DESCRIPTION OF THE DRAWING FIGURES

FIG. 1 is a top perspective view of one embodiment of the invention;

FIG. 2 is a bottom perspective view of the device depicted in FIG. 1;

FIG. 3 is a bottom perspective view of the device depicted in FIG. 2, with the bottom layer removed;

FIG. 4 is a cross-sectional view through line A-A of FIG. 2;

FIG. 5 is an enlargement of detail H of FIG. 4, illustrating the utilisation of a metal substrate;

FIG. 6 is a perspective view of another embodiment;

FIG. 7 is an enlargement of detail B of FIG. 6;

FIG. 8 is a schematic diagram suggesting an internal circuit including constant current driver, terminal lugs and thumbscrews;

FIG. 9 is a top perspective view illustrating a recess in a single panel having a relief portion shaped to receive a LED module depicted in FIG. 12;

FIG. 10 is a top perspective view of another embodiment of the invention;

FIG. 11 is a bottom perspective view of the device depicted in FIG. 10;

FIG. 12 is a top perspective view of an LED module having mounting holes at each end and depicting connecting wires;

FIG. 13 is a bottom perspective view of the assembly depicted in FIG. 12;

FIG. 14 is a top perspective view illustrating an embodiment having channels positioned on opposite edges of a shelf; and

FIG. 15 is a bottom perspective view of the device depicted in FIG. 14.

### BEST MODE AND OTHER EMBODIMENTS OF THE INVENTION

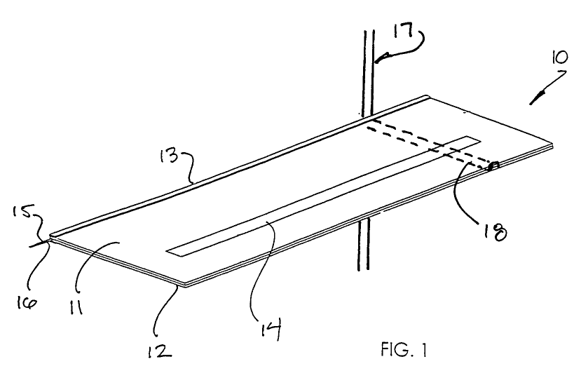

As shown in FIG. 1, a panel such as a furniture panel and more particularly a shelf 10 comprises an upper layer 11 and a lower layer 12. In this embodiment, a U-shaped channel 13, such as a metal channel, extends along the entire rear edge of the shelf 10. The layers 11 and 12 are preferably of similar size and may be made from a variety of materials including glass, metal, acrylic, polycarbonate, wood, high impact acrylonitrile butadiene styrene (ABS), or the like. Tempered glass is a preferred material, particularly for the bottom layer 12. In preferred embodiments a substrate of a lighting module 14 may be visible. The substrate is used to mount lighting devices such as LEDs, and acts as a heat sink as will be explained. Circuit tracks or wiring (not visible in FIG. 1) extends from the substrate 14 toward the rear edge of the shelf and extends between the channel 13 and the layers 11, 12 to a location 15 that is exterior to both the layers 11, 12 and the channel 13. In this way, the wires 16 required to power the light sources may be attached to a power source, in any convenient fashion. As shown in FIG. 1, the shelf 10 may be combined with purpose built or conventional supporting furniture or racking 17. The supporting furniture 17 has arms 18 or other features for holding a shelf 10 in a horizontal orientation. Although horizontal shelves are the most conventional, shelves in general and those of the present invention may be inclined if required. In any event, the shelves of the present invention are not much different in size or weight to conventional shelves thus permitting conventional shelves to be replaced with illuminating shelves of the type disclosed here with practically no modification required to the supporting furniture. Of course, purpose built furniture may be provided to increase ease of installing or supplying power to the units taught by this specification. In some instances, shelving of the present invention may be suspended from cables. The cables may be used to deliver power to the shelf. Additional concealed tracks or wires are used to deliver current from the suspension wires to the module.

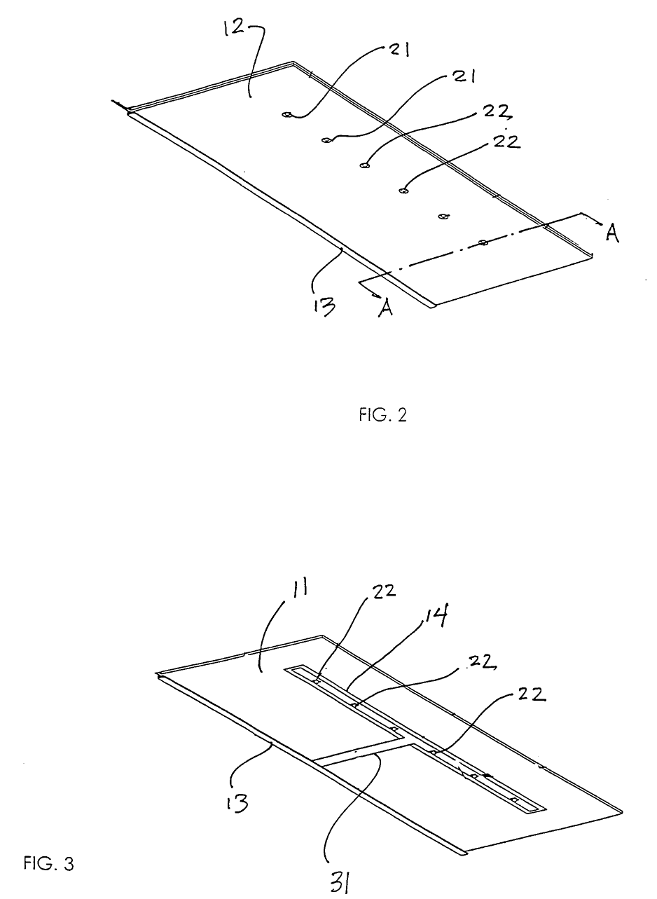

As shown in FIG. 2, the bottom layer 12 comprises a number of openings 21 in registry with the light emitting diode (“LED”) light sources 22 that are carried by the substrate 14. In this example, six LEDs 22 are in registry with the six openings 21. Throughout this specification, LEDs are selected for the purpose of teaching the invention. White light LEDs are particularly useful. However, it will be understood that other miniature light sources may also be similarly employed. In this embodiment, the LEDs 22 do not protrude past the bottom of the lower layer 12. The orientation of the shelf 10 is not limited to having the lights 22 shine downward. The shelf may be used in an inverted orientation so that the lights shine up. In addition, the substrate may be mounted on a slight incline with respect to the shelf by tilting the recess into which the substrate is installed. This cases the lights to shine at an angle other than perpendicular to the shelf. A shelf according to the invention may also have upward and downward shining lights, as required.

As shown in FIG. 3, the substrate 14 is placed in the longitudinal recess of the top layer 11 shaped to fit the perimeter of the substrate or module 14. Electrical wires 31, as previously mentioned, extend from the channel 13 to each of the individual light sources 22. In preferred embodiments, the thickness of the top layer 11 is approximately 0.5 mm or so thicker than the substrate or module 14. In this way, the top layer 11 can be recessed with an opening into which the substrate or module 14 fits. Recesses or grooves may also be provided in the underside of the top panel for the electrical wiring 31, particular 14 portions that extend from the substrate 14 to the channel 13. In this way, the bottom layer 12 may be flush or surface mounted with the top layer 11.

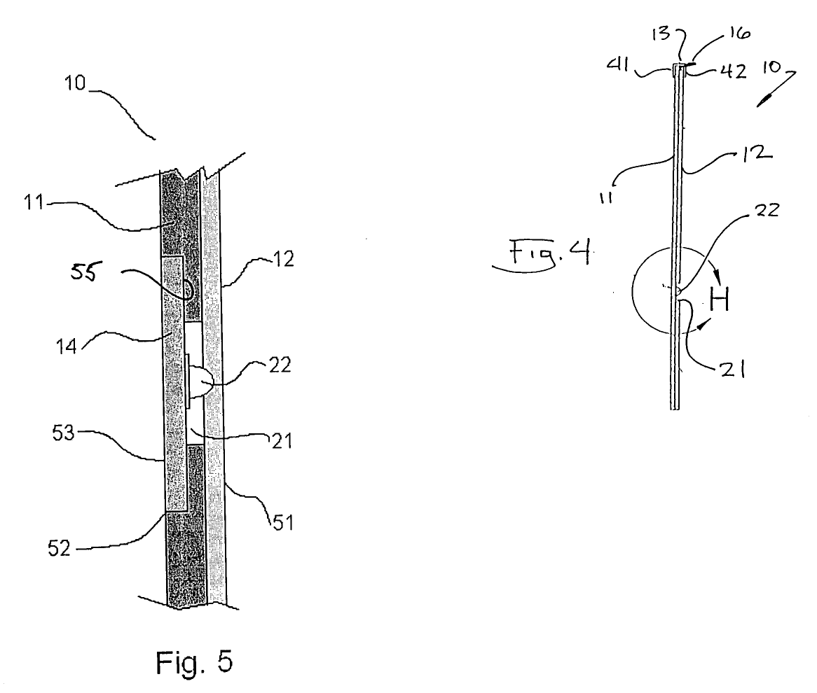

As shown in FIGS. 4 and 5, the recess or opening 52 in the top layer 11 receives the LED module 14 and allows the bottom layer 12 to be flush mounted with respect to both the top layer 11 and the module 14. It has an internal shoulder 55 that locates the module 14. In preferred embodiments the upper surface 53 is exposed, at least in part, to the air, for cooling purposes. Adhesives such as liquid adhesives and adhesive films can be used to join the upper and lower layers 11, 12. As shown more clearly in FIG. 5, the light source (e.g. LED) 22 is preferably positioned so that it does not protrude past the lower surface 51 of the lower layer 12. This allows the shelves 10 to be conveniently stacked. However, in some embodiments, it may be advantageous that the light source extends past the lower surface 51. FIG. 4 also illustrates that the channel 13 has generally parallel side edges 41, 42 between which are located the upper and lower layers 11, 12 and any required wiring.

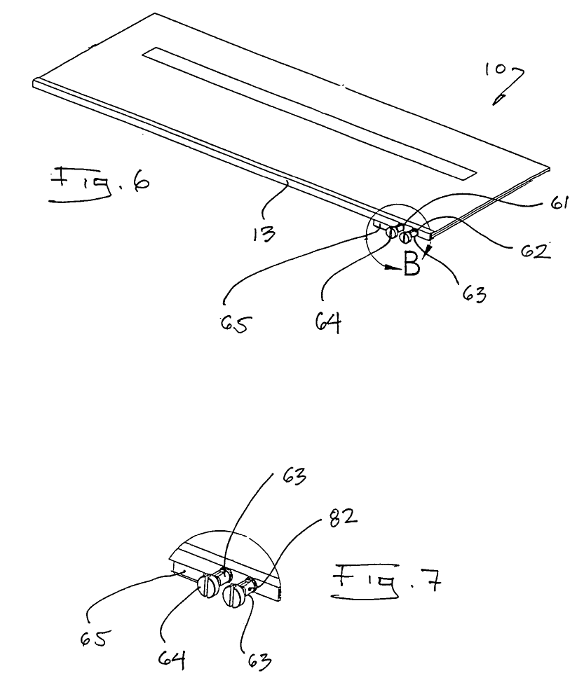

As shown in FIGS. 6, 7 and 8 the rear portion of a shelf 10, particularly the channel 13 may be equipped with a pair of electrical terminals 61, 62 that may be used to interconnect the shelf 10 with a power supply. As suggested by these figures, the channel 13 may have affixed to it a pair of internally threaded posts 63, each adapted to receive a threaded thumbscrew 64. In preferred embodiments, the thumbscrews 64 have a pointed end 81 and the posts 63 are equipped with transverse through openings 82 that allow external wiring to be connected to the shelves' circuitry. FIGS. 6-8 also illustrate the use of a constant current driver which may optionally be incorporated into or onto the channel 13 or other surface of the shelf 10.

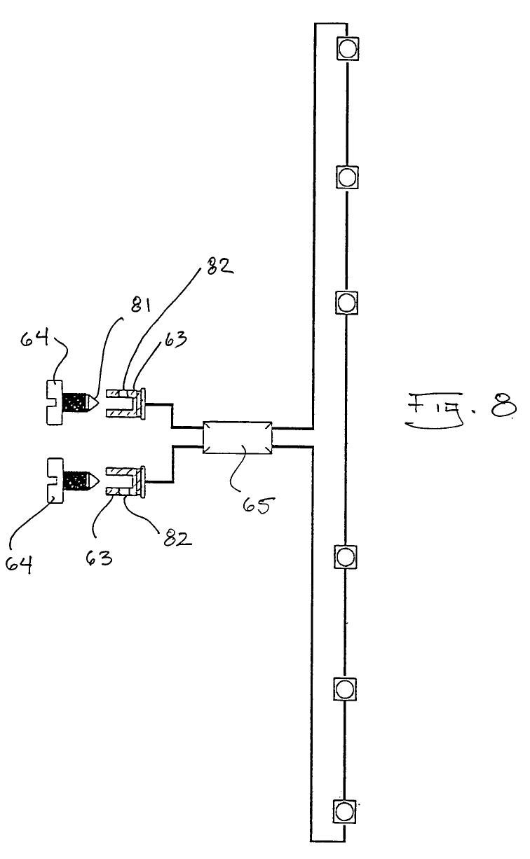

Although FIGS. 6 and 7 depict the terminals 61, 62 as located at one end of the shelf 10, they may be positioned centrally or with one at each end of the shelf or channel. It will be appreciated that small mounting screws may be located within the channel, extending through it to connect the terminals 61, 62 to the channel. Insulators between the terminals 61, 62 and the channel 13 may be required where the channel 13 is metallic.

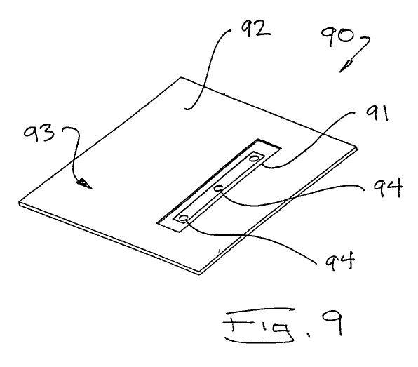

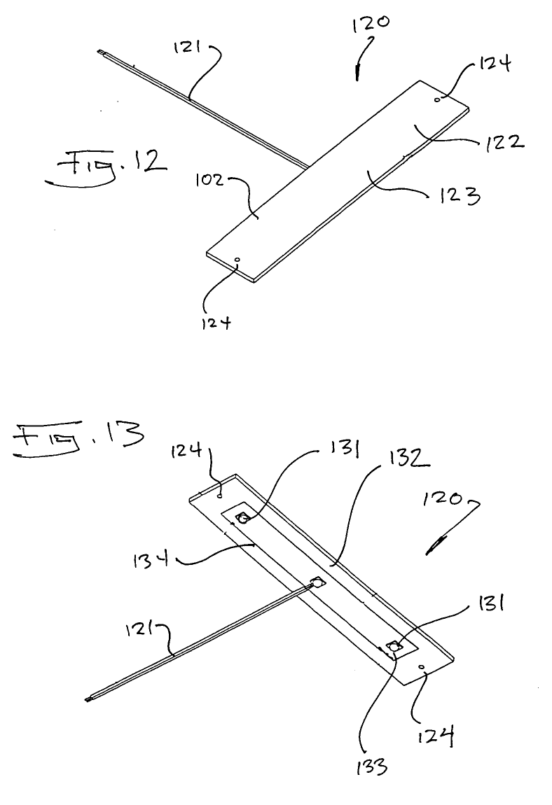

A further embodiment of the invention is depicted in FIGS. 9-11. In this embodiment, a single layer shelf 90 is depicted. The single layer depicted in FIGS. 9-11 may be polymeric or wooden and formed to include a recess 91 on the upper surface 92 of the single layer 93. In this example, the recess 91 is shaped to accommodate an illumination module 120 of the type depicted in FIGS. 12 and 13. In this example, the recess 91 is rectangular and extends to a depth that allows the module 120 to be flush mounted with respect to the upper surface 92 and exposed to the air. The recess 91 includes one or more through openings 94. The openings 94 allow light from the illumination sources such as LEDs to be transmitted past the lower surface of the layer 92. In this example, three openings 94 are provided for three LEDs.

As shown in FIG. 10, the upper surface 101 of the single layer shelf 90 is flush with the upper surface 102 of the module 120. It is also shown that the perimeter of the recess 91 is shaped to fit the perimeter of the module 102. Electrical wires 121 from the module 102 extend toward the rear-located channel 103 and pass under it in ways that have been previously disclosed. The electrical wiring 121 can be affixed to the underside of the shelf 90 or can be fitted into a groove on either the upper or lower surfaces of the shelf, the groove extending toward the channel 103. In some embodiments, the module 120 may be self-powered by batteries.

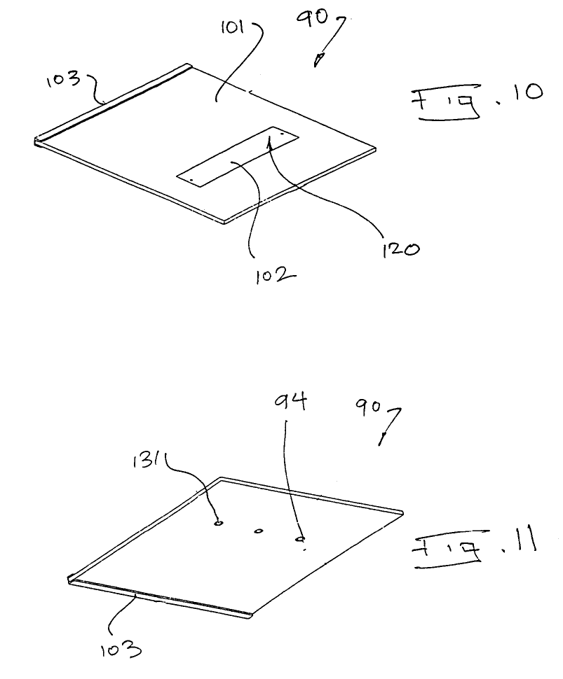

As shown in FIG. 11 the openings 94 are in registry with the LEDs 131 that are associated with the module 120. It will be appreciated that any number of LEDs may be incorporated into the module and that modules of various shapes and sizes may be employed. In one embodiment the shelf 90 is preferably thick enough that the LEDs do not protrude.

As shown in FIGS. 12 and 13, a user-installed module 120 comprises a substrate 122 that supports one or more LEDs or other sources of illumination 131 and associated circuitry. The upper surface 123 of the module is intended to be flush mounted to an underside of a shelf. For this purpose, it may be provided, at each end with through openings 124 that allow screws to pass through the module into the shelf 90. The module may also be adhered to the shelf 90, as required. As shown in FIG. 13, the underside 132 of the module 120 includes fixtures 133 for retaining the LEDs 131 as well as circuit components 134 required to distribute electricity 121 to each of the LEDs 131. It will be appreciated that this circuitry, as with previous examples may be in the form of hard wiring or printed circuit components of either a rigid or flexible variety. The metal substrate may be coated with an electrically insulating material that is sufficiently thermally conductive to allow the substrate to act as a heat sink and still electrically isolate the substrate from the electrical circuits, tracks and components that may be associated with the LEDs. Batteries may be used in place of an external power supply. The user-installed module described above may be capped with a second or bottom layer, generally coextensive with the substrate and formed with through holes in registry with the LEDs, effectively concealing them. This bottom layer may be provided to match or compliment or blend in with the user's shelves to which it is attached.

It will be appreciated that in some embodiments, the module substrate 132 may be metallic. The advantage of using a metallic substrate is that it acts as a heat sink for the LEDs. If required, the upper panel can also be made out of metal so as to create an even larger heat sink effect. Thus, the size of the substrate will depend of the number of LEDs being used and the rate of heat dissipation required for the particular application. Where a metal plate is used as a substrate, it can carry a coating of thermally conductive dielectric material that may serve as an insulator between the substrate itself and copper traces that are plated onto the dielectric for the purpose of distributing current to the LEDs. The lower surface of the substrate may be coated with a chemical compound such as epoxy, polyurethane or the like, to embed the LEDs or to pot them, thus providing additional resistance to mechanical injury as well as protection from moisture and stray current.

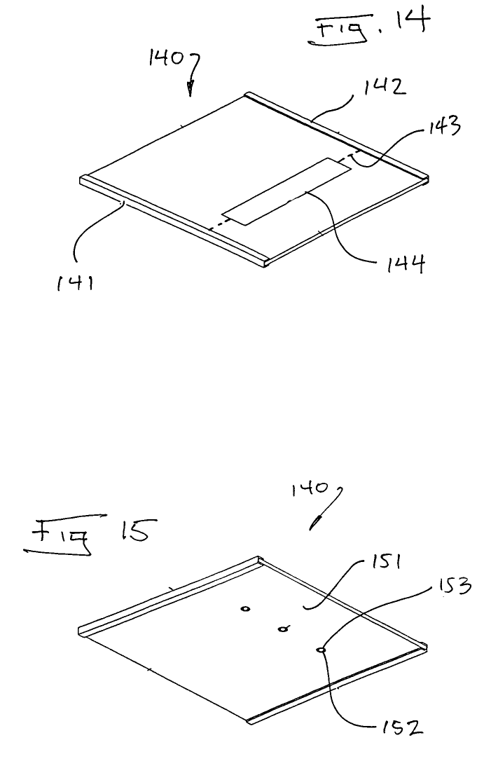

Another embodiment of the invention is depicted in FIGS. 14 and 15. FIGS. 14 and 15 are illustrated with reference to a single layer shelf but it will be appreciated that the primary teachings of FIGS. 14 and 15 relate to the use of a pair of channels 141, 142 located on opposite side edges of the shelf 140. Prior examples of the invention have illustrated the use of a channel, particularly metallic channel along the rear edge. In this embodiment, individual wires comprising the LEDs power circuitry can be embedded beneath each of the side-located channels 141, 142. This provides the opportunity of providing separately exiting wires, or separate electrical terminals or contacts on the side edges rather than on the rear edge of the shelf 140. Electrical leads 143 can be seen exiting the opposite ends of the module 144. In some embodiments, the electrical leads from the one or more LEDs can be connected to each of the side edges 141, 142, thus allowing power to flow to the LEDs simply by resting the side edges 141, 142 on electrically charged supporting surfaces such as metallic supporting arms that may be associated with the shelving furniture that supports the shelf 140. As shown in FIG. 15, the underside 151 of the shelf 140 comprises openings 152 which are in registry with the LEDs 153.

While the present invention has been disclosed with reference to particular details and methods of construction, these should be understood as having been provided by way of example and not as limitations to the scope or spirit of the invention as expressed in the claims.

What is claimed is:

1. A shelf, comprising:
a first panel having an upper surface and a lower surface;
the upper surface having formed in it a recess;
the recess having located in it a module carrying one or more sources of illumination;
the recess further comprising a through opening;
at least one of the sources of illumination being adapted to shine through the opening.

2. The shelf of claim 1, wherein:
an upper surface of the module is flush with the upper surface of the panel.

3. The shelf of claim 1, wherein:
the one or more sources of illumination do not protrude from the lower surface of the panel.

4. The shelf of claim 1, further comprising:
a second panel, attached to the underside of the first panel and of similar size and having a number of through openings formed in it, each through opening being in registry with one of the sources of illumination.

5. The shelf of claim 1, further comprising:
a channel, coextensive with a rear edge of the first panel;
the channel concealing a wire that carries power to the module.

6. The shelf of claim 5, wherein:
the wire is carried to the module in a groove formed in the first panel.

7. The shelf of claim 4, wherein:
the second panel is made from glass and the first panel is not glass.

8. The shelf of claim 1, wherein:
the module has a substrate that is exposed to air and made from a metal, acting as a heat sink for the sources of illumination.

9. The shelf of claim 1, wherein:
the sources of illumination are LEDs.

10. The shelf of claim 4, wherein:
the sources of illumination do not protrude through the through openings of the second panel.

11. The shelf of claim 1, wherein:
the recess has an internal shoulder for supporting the module.

12. The shelf of claim 5, wherein:
the channel has affixed to it, terminals that are connected electrically to the module.

13. The shelf of claim 1, wherein:
each side edge is concealed by a coextensive channel;
at least one channel concealing a wire that carries power to the module.

14. The shelf of claim 1, wherein:
each side edge is concealed by a coextensive channel;
both channels concealing a wire that carries power to the module.

15. The shelf of claim 1, wherein:
each side edge is concealed by a coextensive channel;
both channels being metal and connected by a wire that carries power to the module.

17. The shelf of claim 1, wherein:
the module is powered by one or more batteries carried by the module.

18. A module for supporting one or more sources of illumination, comprising:
a thin metal substrate on which are mounted to an underside of the substrate the one or more sources, the substrate acting as a heat sink and having one or more mounting holes through it.

19. A shelf, comprising:
a first panel having an upper surface and a lower surface;
the upper surface having formed in it a recess;
the recess having located in it a module carrying one or more sources of illumination;
the recess further comprising a through opening;
at least one of the sources of illumination being adapted to shine through the opening; and
a second panel, attached to the underside of the first panel and having a number of through openings formed in it, each through opening being in registry with one of the sources of illumination.

20. The shelf of claim 19, wherein:
the substrate presents a metal surface flush with the upper surface of the first panel and the sources are LEDs.
